(19) United States
(12) Patent Application Publication
(10) Pub. No.: US 2025/0118791 A1
(43) Pub. Date: Apr. 10, 2025

(54) ALL-SOLID-STATE BATTERY ASSEMBLY

(71) Applicants: Hyundai Motor Company, Seoul (KR); Kia Corporation, Seoul (KR)

(72) Inventors: Ji Young Kim, Seoul (KR); Sam Ick Son, Seoul (KR); Ki Yoon Bae, Seoul (KR)

(21) Appl. No.: 18/829,066

(22) Filed: Sep. 9, 2024

(30) Foreign Application Priority Data
Oct. 5, 2023 (KR) 10-2023-0132642

(51) Int. Cl. H01M 10/04

(52) U.S. Cl. CPC H01M 10/0468; H01M 2200/20

(57) ABSTRACT

Disclosed is an all-solid-state battery assembly including an all-solid-state battery including a plurality of electrode layers and a plurality of solid-electrolyte layers laminated in a lamination direction; a housing accommodating the all-solid-state battery; a constraining pad between a first inner surface of the housing and the all-solid-state battery in the lamination direction; and a driving unit connected to the constraining pad to cause the constraining pad to control a magnitude of a pressure applied to the all-solid-state battery.

### CROSS-REFERENCE TO RELATED APPLICATION

This application claims the benefit of Korean Patent Application No. 10-2023-0132642, filed in the Korean Intellectual Property Office on Oct. 5, 2023, the entire contents of which are incorporated herein by reference.

### BACKGROUND

### Technical Field

The present disclosure relates to an all-solid-state battery assembly.

### Background

Unlike primary batteries, which cannot be recharged after discharge, secondary batteries, which may be reused through charging after discharge, may be applied to various fields such as smartphones, automobiles, drones, and robots, and their importance is increasing day by day.

As secondary batteries according to the existing technologies use liquid as an electrolyte, there is a problem of poor stability, such as explosions and fires when expansion due to temperature changes or leakage due to external shock occurs, and to solve these problems, research and development on all-solid-state batteries are being actively conducted.

The all-solid-state battery has high structural stability, as the electrolyte located between positive and negative active material layers is formed of solid, and thus there is no need to provide safety-related items such as separators, and the battery may be miniaturized with high energy density. However, in the case of an all-solid-state battery, there are limitations such as expansion and contraction of the electrode active material during charging/discharging. As a result, the interface between the electrode active material and the solid electrolyte may separate, reducing performance.

### SUMMARY

In one aspect, the present disclosure has been made to solve the above-mentioned problems occurring in the existing technologies while advantages achieved by the existing technologies are maintained intact.

An embodiment of the present disclosure provides provide an all-solid-state battery assembly that may control a pressure of an all-solid-state battery.

An embodiment of the present disclosure may provide an all-solid-state battery assembly that may acquire a pressure of an all-solid-state battery in realtime, and may control pressure based on acquired data.

The technical problems to be solved by the present disclosure are not limited to the aforementioned problems, and any other technical problems not mentioned herein will be clearly understood from the following description by those skilled in the art to which the present disclosure pertains.

An embodiment of the present disclosure may provide an all-solid-state battery assembly that may acquire a pressure of an all-solid-state battery in realtime, and may control pressure based on acquired data.

According to an embodiment of the present disclosure, an all-solid-state battery assembly may include an all-solid-state battery comprising a plurality of electrode layers and a plurality of solid-electrolyte layers are laminated in a specific lamination direction, a housing accommodating the all-solid-state battery, a constraining pad between a first inner surface of the housing and the all-solid-state battery in the lamination direction, and a driving unit connected to the constraining pad to cause the constraining pad to control a magnitude of a pressure applied to the all-solid-state battery.

The driving unit may be configured to adjust a distance between the constraining pad and a second inner surface of the housing that is opposite to the first inner surface of the housing.

The constraining pad may be disposed to be spaced apart from the second inner surface of the housing, which overlaps the all-solid-state battery in the lamination direction to support the all-solid-state battery when pressed by the constraining pad, in the lamination direction.

The driving unit may be located between the second inner surface of the housing, which supports the all-solid-state battery when pressed by the constraining pad, and the constraining pad, to control a magnitude of a pressure applied to the all-solid-state battery by the constraining pad through a change in a length thereof.

The driving unit may include a fixing part protruding from the second inner surface of the housing, which supports the all-solid-state battery when pressed by the constraining pad, in the lamination direction, a coupling part coupled to the fixing part to be moved relatively to the fixing part in the lamination direction, and a driving part connected to the coupling part, and that drives the coupling part such that the coupling part is moved with respect to the fixing part.

The coupling part may be screw-coupled to the fixing part, and the driving part may be configured to rotate the coupling part.

The driving part may be a rotary motor.

The all-solid-state battery assembly may further include a pressure acquisition unit overlapping the all-solid-state battery in the lamination direction to acquire a magnitude of a pressure applied to the all-solid-state battery in the lamination direction.

The pressure acquisition unit may include a first pressure acquisition unit stacked between the constraining pad and the all-solid-state battery, and a second pressure acquisition unit stacked between the second inner surface of the housing, which supports the all-solid-state battery when pressed by the constraining pad, and the all-solid-state battery.

The all-solid-state battery assembly may further include a processor that drives the driving unit based on the pressure of the all-solid-state battery, which is acquired by the pressure acquisition unit.

The pressure may control driving of the driving unit based on a difference value between a preset initial pressure of the all-solid-state battery and a measured pressure of the all-solid-state battery.

The processor may control the driving unit such that the driving unit is driven when a ratio of the difference value to the preset initial pressure is more than a preset indicator value.

The processor may control a driving direction of the driving unit such that the pressure of the all-solid-state battery decreases when a ratio of the difference value to the preset initial pressure is more than a preset indicator value and the measured pressure of the all-solid-state battery is more than the preset initial pressure.

The processor may control a driving direction of the driving unit such that the pressure of the all-solid-state battery increases when a ratio of the difference value to the preset initial pressure is more than a preset indicator value and the measured pressure of the all-solid-state battery is the preset initial pressure or less.

The at least one driving unit may be a pair of driving units, and the pair of driving units may be provided on one side and an opposite side of the all-solid-state battery.

The constraining pad may have elasticity and a thickness of the constraining pad may be configured to change depending on a pressure applied to the constraining pad.

The constraining pad may be expanded and contracted in the lamination direction in the interior of the housing as the driving unit is driven.

In some embodiments, provided is an all-solid-state battery assembly comprising: an all-solid-state battery comprising a plurality of electrode layers and a plurality of solid-electrolyte layers laminated in a lamination direction; a housing accommodating the all-solid-state battery; a constraining pad between a first inner surface of the housing and the all-solid-state battery in the lamination direction; a driving unit connected to the constraining pad to cause the constraining pad to control a magnitude of a pressure applied to the all-solid-state battery; and a pressure acquisition unit disposed between the constraining pad and the all-solid-state battery.

The driving unit may be disposed between the constraining pad and a second inner surface of the housing that is opposite to the first inner surface of the housing.

In some embodiments, provided is an all-solid-state battery assembly comprising: an all-solid-state battery comprising a plurality of electrode layers and a plurality of solid-electrolyte layers laminated in a lamination direction; a housing accommodating the all-solid-state battery; a constraining pad between a first inner surface of the housing and the all-solid-state battery in the lamination direction; a driving unit connected to the constraining pad to cause the constraining pad to control a magnitude of a pressure applied to the all-solid-state battery; and a pressure acquisition unit disposed between the all-solid-state battery and a second inner surface of the housing that is opposite to the first inner surface of the housing.

As discussed, the method and system suitably include use of a controller or processer.

A term “all-solid-state battery” as used herein includes a rechargeable secondary battery that includes an electrolyte in a solid state, e.g., gel or polymer (cured) or solid material, which may include an ionomer and other electrolytic components for transferring ions between the electrodes of the battery.

In further aspects, vehicles are provided that comprise an all-solid-state battery as disclosed herein.

### BRIEF DESCRIPTION OF THE DRAWINGS

The above and other objects, features and advantages of the present disclosure will be more apparent from the following detailed description taken in conjunction with the accompanying drawings:

FIG. 1 is a perspective view illustrating a housing of an all-solid-state battery assembly according to an embodiment of the present disclosure;

FIG. 2 is a schematic view of an internal structure of a housing of an all-solid-state battery assembly, viewed from a direction that is perpendicular to a lamination direction, according to an embodiment of the present disclosure;

FIG. 3 is a schematic view of an internal structure of a housing of an all-solid-state battery assembly, viewed from a lamination direction, according to an embodiment of the present disclosure;

FIGS. 4 and 5 are schematic views illustrating a driving scheme of a driving unit of an all-solid-state battery assembly according to an embodiment of the present disclosure;

FIG. 6 is a schematic view illustrating a driving scheme of an all-solid-state battery assembly according to another embodiment of the present disclosure;

FIG. 7 is a circuit diagram conceptually illustrating an all-solid-state battery according to an embodiment of the present disclosure; and

FIG. 8 is a flowchart illustrating a process of controlling a pressure of an all-solid-state battery of an all-solid-state battery assembly according to an embodiment of the present disclosure.

### DETAILED DESCRIPTION

Hereinafter, preferred embodiments of the present disclosure will be described in detail with reference to the attached drawings so that those skilled in the art may easily implement the present disclosure. The following description is one of several embodiments of the embodiments, and in describing one embodiment, detailed descriptions of known functions or configurations are omitted to clarify the gist of the present disclosure.

When adding reference numerals to components in each drawing in this specification, identical or similar reference numerals are used for identical or similar components throughout the specification. Components included in one embodiment and components including common functions will be described using the same names in other embodiments. Terms or words used in this specification and claims should not be construed as limited to their ordinary or dictionary meanings, and have to be interpreted with meaning and concept consistent with the technical idea of the present disclosure, based on the principle that the inventor has to appropriately define the concept of terms in order to describe his or her invention in the best way.

In addition, the present disclosure is not limited to the above-described embodiments, and various modifications and variations may be made from these descriptions by those with ordinary knowledge in the field, to which the present disclosure belongs. Therefore, the idea of the present disclosure should not be limited to the above-described embodiments, and the scope of the patent claims described later as well as all things that are equivalent or equivalent to the scope of the patent claims are said to fall within the scope of the idea of the present disclosure.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-of”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

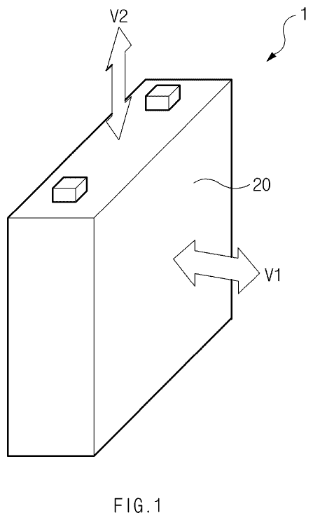

FIGS. 1 to 3 illustrate a structure of an all-solid-state battery assembly 1 according to an embodiment of the present disclosure.

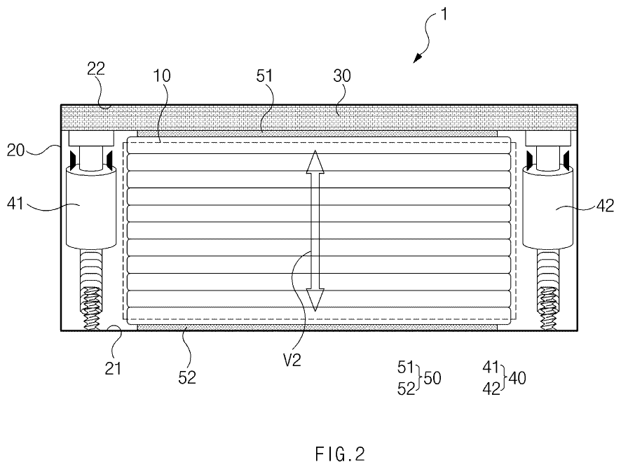

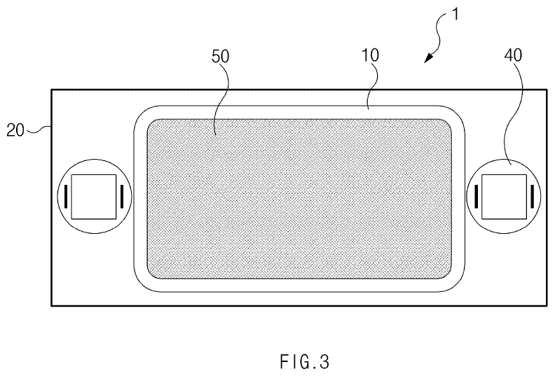

FIG. 1 is a perspective view illustrating a housing 20 of the all-solid-state battery assembly 1 according to an embodiment of the present disclosure, FIG. 2 is a schematic view of an internal structure of the housing 20 of the all-solid-state battery assembly 1 according to an embodiment of the present disclosure, and FIG. 3 is a schematic view of the internal structure of the housing 20 of the all-solid-state battery assembly 1, viewed from another direction, according to an embodiment of the present disclosure.

In detail, FIG. 2 is a schematic view of a shape of the internal structure of the housing 20, viewed from a first direction v1 that is perpendicular to the lamination direction of the all-solid-state battery, and FIG. 3 is a schematic view of the internal structure of the housing 20 of the all-solid-state battery assembly 1, viewed from a second direction v2 that is the lamination direction of the all-solid-state battery, according to an embodiment of the present disclosure (see FIG. 1). However, it is noted that a shape of a constraining pad 30 is omitted for understanding of the internal structure in FIG. 3. Furthermore, it is noted in advance that FIGS. 2 and 3 are schematic views conceptually illustrating components that are disposed in an interior of the housing 20 and shapes or disposition structure of the components are not directly limited to the illustrations.

Structure of all-Solid-State Battery Assembly 1

Referring to FIG. 2, the all-solid-state battery assembly 1 according to an embodiment of the present disclosure may include an all-solid-state battery 10, the housing 20, the constraining pad 30, and a driving unit 40.

The all-solid-state battery 10 may be configured such that a plurality of electrode layers and a plurality of solid-electrolyte layers are laminated along a specific lamination direction. The plurality of electrode layers may include a positive electrode layer and a negative electrode layer, and for example, the all-solid-state battery 10 may be configured such that a positive electrode layer, a solid-electrolyte layer, a negative electrode layer, and a solid-electrolyte layer are repeatedly laminated in a sequence thereof.

The housing 20 may be configured to accommodate the all-solid-state battery 10. The housing 20 may serve as a frame that accommodates the all-solid-state battery 10 and supports the all-solid-state battery 10 to maintain a shape of the all-solid-state battery 10. The housing 20, for example, may be configured to have a shape of an angular case that surrounds the all-solid-state battery 10.

The all-solid-state battery 10 may be laminated in a direction from one inner surface 21 of the housing 20 toward an opposite inner surface 22 thereto, and the one inner surface 21 and the opposite inner surface 22 of the housing 20 may be surfaces that are opposite to each other. The one inner surface 21 of the housing 20 may provide support for the all-solid-state battery 10 when pressed by the constraining pad 30. Areas of the one inner surface 21 and the opposite inner surface 22 of the housing 20 may be larger than an area of the all-solid-state battery 10. Here, the area of the all-solid-state battery 10 may refer to a cross-sectional area perpendicular to its lamination direction. For example, the all-solid-state battery 10 may be positioned at a central portion of the one inner surface 21 and the opposite inner surface 22 of the housing 20.

The constraining pad 30 may be configured to press the all-solid-state battery 10 in the lamination direction. The constraining pad 30 may be disposed in an interior of the housing 20. The constraining pad 30 may be disposed to overlap the all-solid-state battery 10. The constraining pad 30 may have a shape that covers the all-solid-state battery 10, with an area larger than the area of the all-solid-state battery 10. The constraining pad 30, for example, may have a size corresponding to the inner surface of the housing 20.

One surface of the constraining pad 30 faces one surface of the all-solid-state battery 10, while the opposite surface of the constraining pad 30 may contact the opposite inner surface 22 of the housing 20. Essentially, the all-solid-state battery 10 and the constraining pad 30 may be sequentially disposed in a direction from the one inner surface 21 toward the opposite inner surface 22 of the housing 20.

Pressure of all-Solid-State Battery 10

The all-solid-state battery 10 may be pressed between the one inner surface 21 and the constraining pad 30 of the housing 20. That is, the one inner surface 21 of the housing 20 and the constraining pad 30 may press the all-solid-state battery 10 therebetween, and thus, a specific pressure may be generated in the all-solid-state battery 10 in the lamination direction. That is, the pressure of the all-solid-state battery 10 may mean a pressure that is generated in the lamination direction of the all-solid-state battery 10 as the all-solid-state battery 10 is pressed between the one inner surface 21 of the housing 20 and the constraining pad 30.

Then, a pressure applied to the all-solid-state battery 10 may increase when a distance between the constraining pad 30 and the one inner surface 21 of the housing 20 decreases, and to the contrary, the pressure applied to the all-solid-state battery 10 may decrease when the distance between the constraining pad 30 and the one inner surface 21 of the housing 20 increases. The distance between the constraining pad 30 and the one inner surface 21 of the housing 20 may be adjusted by the driving unit 40.

### Driving Unit 40

The driving unit 40 may be configured to control the pressure applied to the all-solid-state battery 10 by the constraining pad 30. The driving unit 40 may be provided in an interior of the housing 20. The driving unit 40 may be provided in an interior of the housing 20, and may be disposed to be spaced apart from the all-solid-state battery 10 by a specific distance.

The driving unit 40 may be connected to the constraining pad 30. The driving unit 40 may be connected to the one inner surface 21 of the housing 20. The driving unit 40 may connect the constraining pad 30 and the one inner surface 21 of the housing 20. The driving unit 40 may extend between the one inner surface 21 of the housing 20 and the constraining pad 30.

The driving unit 40 is configured such that a length thereof may be changed. Because the length of the driving unit 40 is changed between the one inner surface 21 of the housing 20 and the constraining pad 30, a distance between the one inner surface 21 of the housing 20 and the constraining pad 30 may be adjusted, and thus, the pressure applied to the all-solid-state battery 10 may be controlled through driving of the driving unit 40.

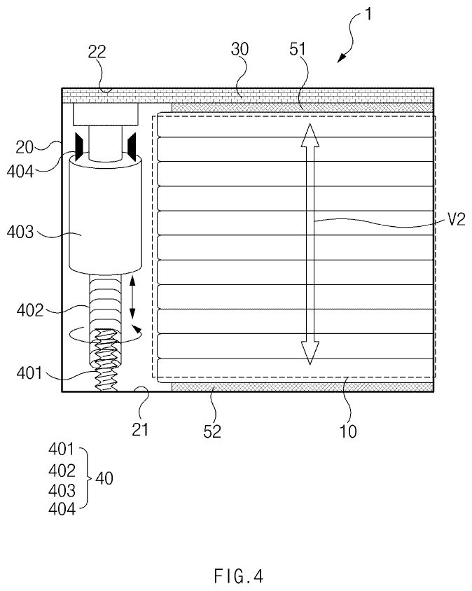

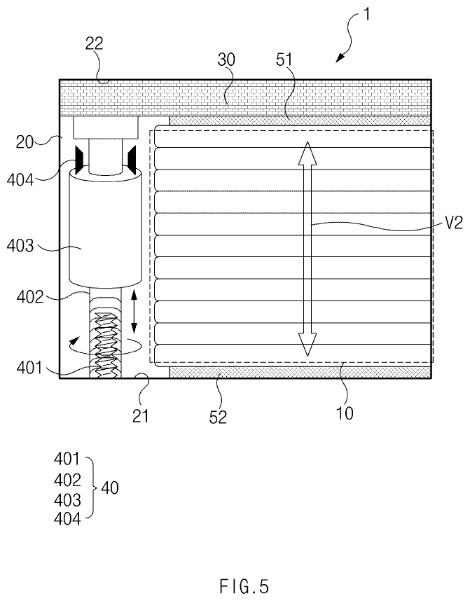

For example, when the length of the driving unit 40 becomes shorter, the distance between the one inner surface 21 of the housing 20 and the constraining pad 30 may decrease, leading to the increased pressure applied to the all-solid-state battery 10. Conversely, when the length of the driving unit 40 becomes longer, the distance between the one inner surface 21 of the housing 20 and the constraining pad 30 may increase, resulting in decreased pressure applied to the all-solid-state battery 10. The driving mechanism of the driving unit 40 will be described in detail with reference to FIGS. 4 and 5, which will be described below.

A plurality of driving units 40 may be provided. A pair of driving units 40, for example, may be provided on opposite sides of the all-solid-state battery 10. The driving units 40 may include a first driving unit 41 that is disposed on one side of the all-solid-state battery 10, and a second driving unit 42 that is disposed on an opposite side of the all-solid-state battery 10. The first driving unit 41 and the second driving unit 42 may be controlled to have the same length to apply a uniform pressure to the all-solid-state battery 10.

However, the number and the disposition form of the driving units 40 are not limited thereto, and if necessary, a larger number of driving units 40 may be provided around the all-solid-state battery 10.

### Pressure Acquisition Unit 50

The all-solid-state battery assembly 1 according to an embodiment of the present disclosure may further include the pressure acquisition unit 50.

The pressure acquisition unit 50 may be configured to acquire the pressure of the all-solid-state battery 10. The pressure acquisition unit 50 may be configured to be stacked on the all-solid-state battery 10. The pressure acquisition unit 50 may overlap the all-solid-state battery 10 in the form of a flat panel, and for example, may be a pressure sensor.

A plurality of pressure acquisition units 50 may be provided. The pressure acquisition unit 50 may include a first pressure acquisition unit 51 that is stacked between the constraining pad 30 and the all-solid-state battery 10, and a second pressure acquisition unit 52 that is stacked between the one inner surface 21 of the housing 20 and the all-solid-state battery 10. Accordingly, the second pressure acquisition unit 52, the all-solid-state battery 10, the first pressure acquisition unit 51, and the constraining pad 30 may be sequentially stacked in a direction from the one inner surface 21 toward the opposite inner surface 22 of the housing 20.

The pressure acquisition unit 50 may acquire the pressure of the all-solid-state battery 10 between the one inner surface 21 of the housing 20 and the constraining pad 30 in real time, and may be electrically connected to the processor that will be described later to provide pressure data that is a basis of control of the driving units 40.

### Driving Principle of Driving Unit 40

FIGS. 4 and 5 are schematic views illustrating a driving scheme of the driving unit 40 of the all-solid-state battery assembly 1 according to an embodiment of the present disclosure. FIG. 4 illustrates driving of the driving unit 40 that increases the pressure of the all-solid-state battery 10, and FIG. 5 illustrates driving of the driving unit 40 that decreases the pressure of the all-solid-state battery 10.

Referring to FIGS. 4 and 5, the driving unit 40 of the all-solid-state battery assembly 1 according to an embodiment of the present disclosure may include a fixing part 401, a coupling part 402, and a driving part 403.

The fixing part 401 may be formed on the one inner surface 21 of the housing 20. The fixing part 401 may protrude from the one inner surface 21 of the housing 20. The fixing part 401, for example, may be fixed to the one inner surface 21 of the housing 20 in the form of a screw bolt having a specific length. Then, a lengthwise direction of the fixing part 401 may be the lamination direction of the all-solid-state battery 10.

The coupling part 402 may be coupled to be movable relative to the fixing part 401. For example, the coupling part 402 may be coupled to be rotatable with respect to the fixing part 401. The coupling part 402 may be in the form of a nut that is coupled to the fixing part 401 provided in the form of the screw bolt to be rotatable. That is, the coupling part 402 may have a screw thread, with which the fixing part 401 may be engaged, on an inner surface thereof. The coupling part 402 provided in the form of the nut may be rotated with respect to the fixing part 401, and may be moved in the lengthwise direction of the fixing part 401. Consequently, adjusting the coupling part 402 relative to the fixing part 401 may allow for changes in the length of the driving unit 40.

The driving part 403 may be connected to the coupling part 402, and may drive the coupling part 402 such that the coupling part 402 is moved with respect to the fixing part 401. For example, as described above, when the fixing part 401 and the coupling part 402 are provided in the form of a bolt and a nut to be driven in a screw scheme, the driving part 403 may be configured to rotate the coupling part 402. Then, the driving part 403, for example, may be a rotary motor that is electrically driven.

The driving unit 40 may further include a terminal part 404.

The terminal part 404 may be formed in the driving part 403, and may supply external electric power to the driving part 403 such that the driving part 403 may drive the coupling part 402. The terminal part 404, for example, may be provided in the form of an electrode.

The driving part 403 may be fixed to the constraining pad 30. The constraining pad 30, as described above, may be in contact with the opposite inner surface 22 of the housing 20. The constraining pad 30, for example, may be formed of an elastically deformable material. Accordingly, when the driving part 403 rotates the coupling part 402 and the coupling part 402 is moved along the lengthwise direction of the fixing part 401, a thickness of the constraining pad 30 may be changed in correspondence thereto. Because the distance between the one inner surface 21 and the opposite inner surface 22 of the housing 20 is fixed, the thickness of the constraining pad 30 may decrease when the driving part 403 rotates the coupling part 402 and the length of the driving unit 40 increases, and to the contrary, the thickness of the constraining pad 30 may increase when the length of the driving unit 40 decreases.

The length of the driving unit 40 may increase when the coupling part 402 is rotated in one direction by the driving part 403, and the length of the driving unit 40 may decrease when the coupling part 402 is rotated in an opposite direction. During the process of adjusting the length of the driving unit 40, the distance between the constraining pad 30 and the one inner surface 21 of the housing 20 may be changed, and thus, the pressure of the all-solid-state battery 10 may be controlled. Throughout the adjustment, the pressure acquisition unit 50 may acquire the pressure of the all-solid-state battery 10, and here, the acquisition may comprehensively mean a process of sensing the pressure of the all-solid-state battery 10 or calculating or deriving the pressure of the all-solid-state battery 10 based on the sensed data.

The pressure acquisition unit 50 may acquire the pressure of the all-solid-state battery 10. The pressure acquisition unit 50, as described above, may include the first pressure acquisition unit 51 that is stacked between the constraining pad 30 and the all-solid-state battery 10, and the second pressure acquisition unit 52 that is stacked between the one inner surface 21 of the housing 20 and the all-solid-state battery 10.

### Another Embodiment (Movable Constraining Pad)

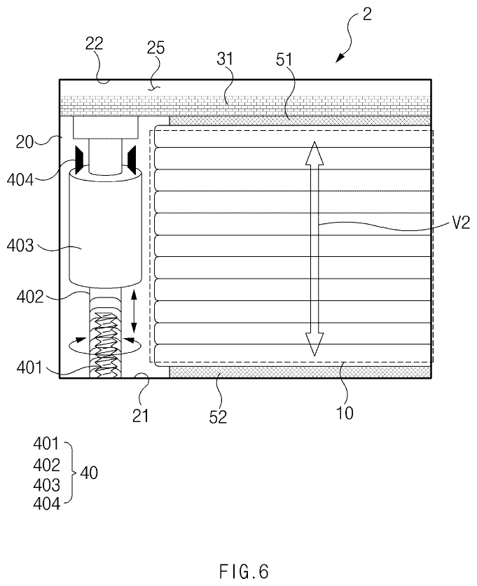

FIG. 6 is a schematic view illustrating a driving scheme of an all-solid-state battery assembly 2 according to another embodiment of the present disclosure.

The all-solid-state battery assembly 2 according to the second embodiment of the present disclosure may differ from the previous embodiment in that the thickness of the constraining pad 30 may not be deformed. The contents that overlap those of the previous embodiment will be omitted, and a difference therebetween will be mainly described with reference to FIG. 6.

Referring to FIG. 6, similarly, in the all-solid-state battery assembly 2 according to the second embodiment of the present disclosure, the length of the driving unit 40 may increase when the coupling part 402 is rotated in one direction by the driving part 403, and the length of the driving unit 40 may decrease when the coupling part 402 is rotated in an opposite direction. In a process of increasing and decreasing the length of the driving unit 40, the distance between a constraining pad 31 and the one inner surface 21 of the housing 20 may be changed, and thus, the pressure of the all-solid-state battery 10 may be controlled.

Then, the constraining pad 31 may be moved in the lamination direction as the length of the driving unit 40 increases and decreases. Then, the lamination direction, in which the constraining pad 31 is moved, may refer to both directions of a direction from the constraining pad 31 toward the one inner surface 21 of the housing 20 and a direction from the constraining pad 31 toward the opposite inner surface 22 of the housing 20. For example, when the length of the driving unit 40 decreases, the constraining pad 31 in contact with the opposite inner surface 22 of the housing 20 also may be moved in the direction, in which the length of the driving unit 40 decreases, and may be spaced apart from the opposite inner surface 22 of the housing 20, and in this case, a space 25 may be generated between the constraining pad 31 and the opposite inner surface 22 of the housing 20.

In other words, as in the previous embodiment, even when the constraining pad is formed of an elastic material such that the thickness thereof is not deformed, the constraining pad 31 may be moved in the lamination direction of the all-solid-state battery 10 according to the driving unit 40, and the pressure of the all-solid-state battery 10 may be controlled.

Structure for Controlling all-Solid-State Battery Assembly

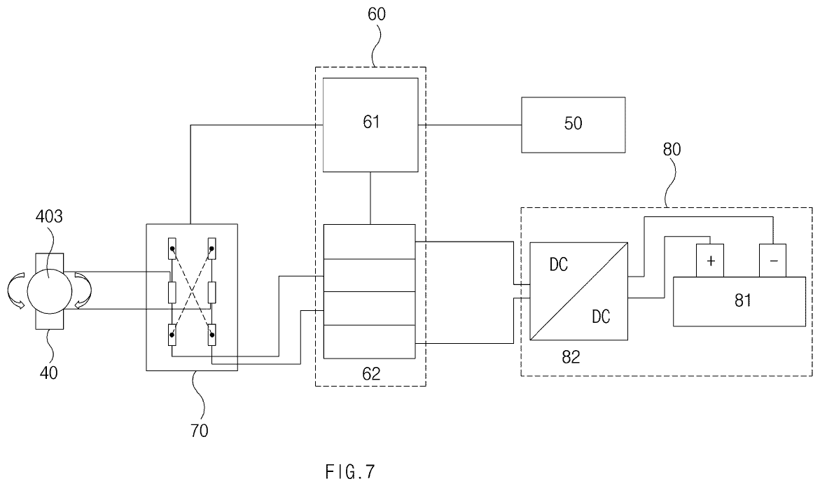

FIG. 7 is a circuit diagram conceptually illustrating the all-solid-state battery assembly according to an embodiment of the present disclosure.

Referring to FIG. 7, the all-solid-state battery assembly according to an embodiment of the present disclosure may further include a processor 60, a switch unit 70, and an electric power unit 80.

The processor 60 may control driving of the driving unit 40 based on the pressure of the all-solid-state battery, which is acquired by the pressure acquisition unit 50 in real time. The processor 60 may include an ECU 61 and a current controller 62.

The ECU 61 and the current controller 62 may be electrically/physically connected to each other. The ECU 61 is an electronic control unit, and may be connected to the pressure acquisition unit 50 to receive the acquired pressure, and compute it to deliver it to the current controller 62. In other words, the ECU 61 may adjust an amount of currents that are necessary for the current controller 62 and input a signal. Furthermore, the ECU 61 may be connected to the switch unit 70, which will be described later, to input a signal for a rotational direction of the driving part 403 to the switch unit 70.

The current controller 62 may receive currents from the electric power unit 80 and may be connected to the ECU 61 to receive a signal from the ECU 61. The electric power unit 80, as will be described later, may be configured to include the all-solid-state battery 10. The current controller 62 may receive currents from the electric power unit 80, and may properly control the amount of the currents that are supplied to the driving part 403 based on the signal received from the ECU 61.

The switch unit 70 may be disposed between the processor 60 and the driving unit 40. The switch unit 70 may be configured to adjust a rotational direction of the driving part 403 of the driving unit 40. The switch unit 70, for example, is a 6-pin switch, and may control the driving part 403 such that the driving part 403 provided in the form of a motor is rotated forwardly and reversely. The switch unit 70 may receive a forward/reverse rotation signal from the ECU 61 of the processor 60, and may receive the currents of an amount that is controlled by the current controller 62 of the processor 60 and deliver them to the driving part 403 of the driving unit 40.

The electric power unit 80 may include a battery 81 and a converter 82. The battery 81 may be configured to supply electric power, and the converter 82 may be a DC-DC converter. Preferably, the battery 81 may be the above-described all-solid-state battery 10 that is accommodated in the housing 20. In other words, the driving unit 40 of the all-solid-state battery assembly according to an embodiment may directly receive electric power from the all-solid-state battery 10 in the housing 20 instead of a separate external power source to be driven.

Algorithm for Controlling Pressure of all-Solid-State Battery

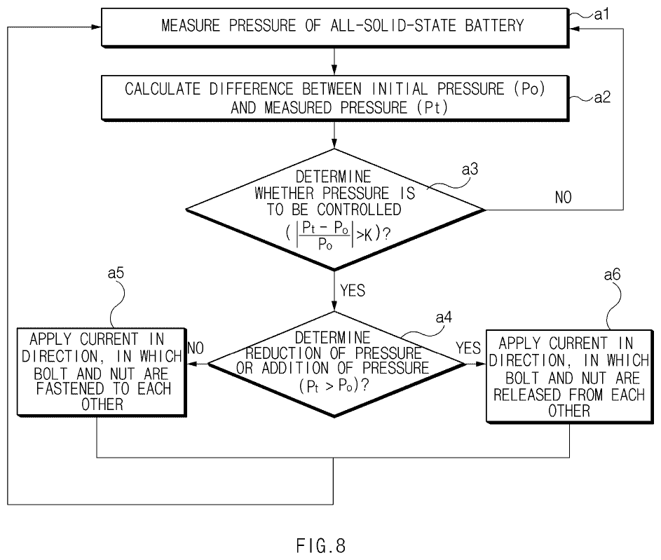

FIG. 8 is a flowchart illustrating a process of controlling the pressure of the all-solid-state battery of the all-solid-state battery assembly according to an embodiment of the present disclosure.

Referring to FIG. 8, the pressure of the all-solid-state battery assembly according to an embodiment of the present disclosure may be controlled by sequentially performing a pressure measuring operation a1, a pressure difference calculating operation a2, determination operations a3 and a4, and control operations a5 and a6.

In the pressure measuring operation a1, the pressure of the all-solid-state battery may be measured, and for example, the changed pressure of the all-solid-state battery in a charging/discharging process may be measured in real time.

Thereafter, in the pressure difference calculating operation a2, the disparity between the preset initial pressure of the all-solid-state battery and the pressure measured in real time may be calculated. Subsequently, the determination operations a3 and a4 are conducted to decide whether pressure adjustment is necessary and to ascertain the method of pressure control.

The determination operation a3 and a4 may include the pressure control determining operation a3 and the pressure control direction determining operation a4.

In the pressure control determining operation a3, it may be determined whether it is necessary to control the pressure through a preset indicator value “K”. The preset indicator value “K” may be set differently depending on sizes and types of various types of various all-solid-state batteries. In the pressure control determining operation a3, a pressure P0 of the all-solid-state battery, which is preset at an initial stage, and a pressure Pt of the all-solid-state battery, which is measured, may be compared, and for example, a difference value between the two may be converted into an indicator value and it may be determined whether the indicator value is more than the preset indicator value “K”.

If it is determined that a difference between the pressure P0 of the all-solid-state battery, which is preset at the initial stage, and the pressure Pt of the all-solid-state battery, which is measured, is a reference range or more, the process proceeds to the pressure control direction determining operation a4 to determine whether addition of pressure (an increase in pressure) or reduction of pressure (a decrease in pressure) is necessary. When it is determined that the difference between the initial pressure P0 of the all-solid-state battery and the measured pressure Pt of the all-solid-state battery is the reference range or less, the operation a1 of measuring the pressure of the all-solid-state battery, which is changed in real time, may be performed again.

In the pressure control direction determining operation a4, it may be determined whether the measured pressure Pt of the all-solid-state battery is higher or lower than the initial pressure P0, and through this, it may be determined whether, among the control operations a5 and a6, the pressure adding operation a5 or the pressure reducing operation a6 is to be performed. When the measured pressure Pt of the all-solid-state battery is more than the initial pressure P0 of the all-solid-state battery, the pressure reducing operation a6 of releasing the bolt and the nut and decreasing the pressure may be performed, and when the measured pressure Pt of the all-solid-state battery is less than the initial pressure P0 of the all-solid-state battery, the pressure adding operation a5 of further fastening the bolt and the nut and increasing the pressure may be performed.

In other words, the control operations a5 and a6 may be performed based on the determination performed in the pressure control direction determining operation a4. In the control operation, the pressure adding operation a5 of increasing the pressure of the all-solid-state battery by reducing the length of the driving unit or the pressure reducing operation a6 of decreasing the pressure of the all-solid-state battery by increasing the length of the driving unit may be selectively performed.

In the pressure adding operation a5, the driving part may be rotated in a direction, in which the fixing part provided in the form of a bolt and the coupling part provided in the form of a nut are fastened to each other. Conversely, in the pressure reducing operation a6, the driving part may be rotated in a direction that loosens the connection between the fixing part and the coupling part.

In all processes of charging and discharging the all-solid-state battery, for example, charging, using, or leaving behind the all-solid-state battery, sequential processes, including the pressure measuring operation a1 to the control operations a5 and a6, may be repeated, and the pressure of the all-solid-state battery may be maintained within a suitable numerical range.

The all-solid-state battery assembly according to an embodiment of the present disclosure may control the pressure of the all-solid-state battery.

The all-solid-state battery assembly according to an embodiment of the present disclosure may acquire the pressure of the all-solid-state battery in real time, and may control pressure based on the acquired data.

In addition, effects that may be easily predicted by a person skilled in the art may be shown from the configurations according to the embodiments of the present disclosure.

The above description is a simple exemplary description of the technical spirits of the present disclosure, and an ordinary person in the art, to which the present disclosure pertains, may make various corrections and modifications without departing from the essential characteristics of the present disclosure.

Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

What is claimed is:

1. An all-solid-state battery assembly comprising:
an all-solid-state battery comprising a plurality of electrode layers and a plurality of solid-electrolyte layers laminated in a lamination direction;
a housing accommodating the all-solid-state battery;
a constraining pad between a first inner surface of the housing and the all-solid-state battery in the lamination direction; and
a driving unit connected to the constraining pad to cause the constraining pad to control a magnitude of a pressure applied to the all-solid-state battery.

2. The all-solid-state battery assembly of claim 1, wherein the driving unit is configured to adjust a distance between the constraining pad and a second inner surface of the housing that is opposite to the first inner surface of the housing.

3. The all-solid-state battery assembly of claim 1, wherein the constraining pad is disposed to be spaced apart from the second inner surface of the housing, which overlaps the all-solid-state battery in the lamination direction to support the all-solid-state battery when pressed by the constraining pad, in the lamination direction.

4. The all-solid-state battery assembly of claim 1, wherein the driving unit is located between the second inner surface of the housing, which supports the all-solid-state battery when pressed by the constraining pad, and the constraining pad, to control a magnitude of a pressure applied to the all-solid-state battery by the constraining pad through a change in a length thereof.

5. The all-solid-state battery assembly of claim 1, wherein the driving unit comprises:
a fixing part protruding from the second inner surface of the housing, which supports the all-solid-state battery when pressed by the constraining pad, in the lamination direction;
a coupling part coupled to the fixing part to be moved relatively to the fixing part in the lamination direction; and
a driving part connected to the coupling part, and configured to drive the coupling part such that the coupling part is moved with respect to the fixing part.

6. The all-solid-state battery assembly of claim 5, wherein the coupling part is screw-coupled to the fixing part, and
wherein the driving part is configured to rotate the coupling part.

7. The all-solid-state battery assembly of claim 6, wherein the driving part is a rotary motor.

8. The all-solid-state battery assembly of claim 1, further comprising:
a pressure acquisition unit overlapping the all-solid-state battery in the lamination direction to acquire a magnitude of a pressure applied to the all-solid-state battery in the lamination direction.

9. The all-solid-state battery assembly of claim 8, wherein the pressure acquisition unit comprises:
a first pressure acquisition unit stacked between the constraining pad and the all-solid-state battery; and
a second pressure acquisition unit stacked between the second inner surface of the housing, which supports the all-solid-state battery when pressed by the constraining pad, and the all-solid-state battery.

10. The all-solid-state battery assembly of claim 7, further comprising:
a processor configured to drive the driving unit based on the pressure of the all-solid-state battery, which is acquired by the pressure acquisition unit.

11. The all-solid-state battery assembly of claim 10, wherein the pressure controls driving of the driving unit based on a difference value between a preset initial pressure of the all-solid-state battery and a measured pressure of the all-solid-state battery.

12. The all-solid-state battery assembly of claim 11, wherein the processor controls the driving unit such that the driving unit is driven when a ratio of the difference value to the preset initial pressure is more than a preset indicator value.

13. The all-solid-state battery assembly of claim 11, wherein the processor controls a driving direction of the driving unit such that the pressure of the all-solid-state battery decreases when a ratio of the difference value to the preset initial pressure is more than a preset indicator value and the measured pressure of the all-solid-state battery is more than the preset initial pressure.

14. The all-solid-state battery assembly of claim 11, wherein the processor controls a driving direction of the driving unit such that the pressure of the all-solid-state battery increases when a ratio of the difference value to the preset initial pressure is more than a preset indicator value and the measured pressure of the all-solid-state battery is the preset initial pressure or less.

15. The all-solid-state battery assembly of claim 1 comprising a pair of driving units,
wherein the pair of driving units are provided on one side and an opposite side of the all-solid-state battery.

16. The all-solid-state battery assembly of claim 1, wherein the constraining pad has elasticity and a thickness of the constraining pad is configured to change depending on a pressure applied to the constraining pad.

17. The all-solid-state battery assembly of claim 1, wherein the constraining pad is configured to be expanded and contracted in the lamination direction in the interior of the housing as the driving unit is driven.

18. An all-solid-state battery assembly comprising:
an all-solid-state battery comprising a plurality of electrode layers and a plurality of solid-electrolyte layers laminated in a lamination direction;
a housing accommodating the all-solid-state battery;
a constraining pad between a first inner surface of the housing and the all-solid-state battery in the lamination direction;
a driving unit connected to the constraining pad to cause the constraining pad to control a magnitude of a pressure applied to the all-solid-state battery; and
a pressure acquisition unit disposed between the constraining pad and the all-solid-state battery.

19. The all-solid-state battery assembly of claim 18, wherein the driving unit is disposed between the constraining pad and a second inner surface of the housing that is opposite to the first inner surface of the housing.

20. An all-solid-state battery assembly comprising:
an all-solid-state battery comprising a plurality of electrode layers and a plurality of solid-electrolyte layers laminated in a lamination direction;
a housing accommodating the all-solid-state battery;
a constraining pad between a first inner surface of the housing and the all-solid-state battery in the lamination direction;
a driving unit connected to the constraining pad to cause the constraining pad to control a magnitude of a pressure applied to the all-solid-state battery; and
a pressure acquisition unit disposed between the all-solid-state battery and a second inner surface of the housing that is opposite to the first inner surface of the housing.
